(19) United States
(12) Patent Application Publication
(10) Pub. No.: US 2014/0240840 A1
(43) Pub. Date: Aug. 28, 2014

(54) OPTICAL MEMBER

(71) Applicant: PANASONIC CORPORATION, Osaka (JP)

(72) Inventor: Takamasa TAMURA, Osaka (JP)

(73) Assignee: PANASONIC CORPORATION, Osaka (JP)

(21) Appl. No.: 14/184,039

(22) Filed: Feb. 19, 2014

(30) Foreign Application Priority Data
Feb. 25, 2013 (JP) 2013-034679
Dec. 25, 2013 (JP) 2013-266800

(51) Int. Cl. G02B 1/11

(52) U.S. Cl. CPC G02B 1/11
USPC 359/601

(57) ABSTRACT

An optical member of the present technique is an optical member that has an anti-reflective structure being optimum for use with an optical system such as an imaging device. The optical member includes: a first face and a second face opposing to each other; a first microstructure part formed at the first face, and including a plurality of unit structures arranged in the first microstructure part; and a second microstructure part formed at the second face, and including a plurality of unit structures arranged in the second microstructure part. The pitch of the unit structures forming the first microstructure part and the pitch of the unit structures forming the second microstructure part are different from each other.

### BACKGROUND OF THE INVENTION

1. Field of the Invention

The present technique relates to an optical member having an anti-reflective structure that suppresses reflection of incident light.

2. Description of the Related Art

In recent years, there has been proposed a variety of optical members having an anti-reflective structure that suppresses reflection of light.

As an exemplary anti-reflective structure, it has been proposed to form, on the surface of an optical member, a microstructure part with a pitch equal to or smaller than the wavelength of incident light. For example, there are a microstructure part formed by regularly arranged linear concave parts or linear convex parts, a microstructure part formed by regularly arranged conical or columnar concave or convex parts, and the like. Such a structure made of a plurality of arranged unit structures is referred to as an “anti-reflective asperity structure: SWS (Subwavelength Structured Surface)”.

Unexamined Japanese Patent Publication No. 2010-271455 discloses an optical member in which the height of the anti-reflective asperity structure is varied to be gradually increased from the side where the incident angle on the optical surface is smaller toward the side where the incident angle on the optical surface is greater.

### SUMMARY OF THE INVENTION

An optical member of the present technique includes: a first face and a second face opposing to each other; a first microstructure part formed at the first face, and including a plurality of unit structures arranged in the first microstructure part; and a second microstructure part formed at the second face, and including a plurality of unit structures arranged in the second microstructure part. The pitch of the unit structures forming the first microstructure part and the pitch of the unit structures forming the second microstructure part are different from each other.

### BRIEF DESCRIPTION OF DRAWINGS

FIG. 1 is a schematic cross-sectional view showing an exemplary optical system used for an imaging device such as a digital camera;

FIG. 2 is a schematic cross-sectional view showing an exemplary second lens as an optical member according to one embodiment of the present technique;

FIGS. 3A and 3B are each an explanatory diagram for describing an occurrence of transmitted diffracted light;

FIG. 4 is a graph showing a result of calculating the maximum pitch with which unnecessary diffracted light does not occur, in which the relationship between the incident angle of a light beam and the maximum pitch of microstructure parts is shown.

FIG. 5 is a graph showing a result of calculating the maximum pitch with which unnecessary diffracted light does not occur, in which the relationship between the refractive index and the maximum pitch of microstructure parts is shown;

FIG. 6 is a graph showing a result of calculating the maximum pitch with which unnecessary diffracted light does not occur, in which the relationship between the slope of a face and the maximum pitch of microstructure parts is shown; and

FIGS. 7A to 7F each show a step of fabricating a lens mold for molding the lens shown in FIG. 2, in a lens manufacturing method of the present technique.

### DETAILED DESCRIPTION OF THE PREFERRED EMBODIMENT

In the following, with reference to drawings, a detailed description will be given of an optical member according to one embodiment of the present technique. However, a detailed description more than necessary may be omitted. For example, a detailed description of a well-known matter may be omitted, and a description of substantially identical structures may not be repeated. This is to avoid unnecessary redundancies in the following description, and to facilitate understanding of a person skilled in the art.

Note that the inventor provide the following description and accompanying drawings in order for a person skilled in the art to fully understand the present technique. It is not intended to limit the subject matter defined by the claims.

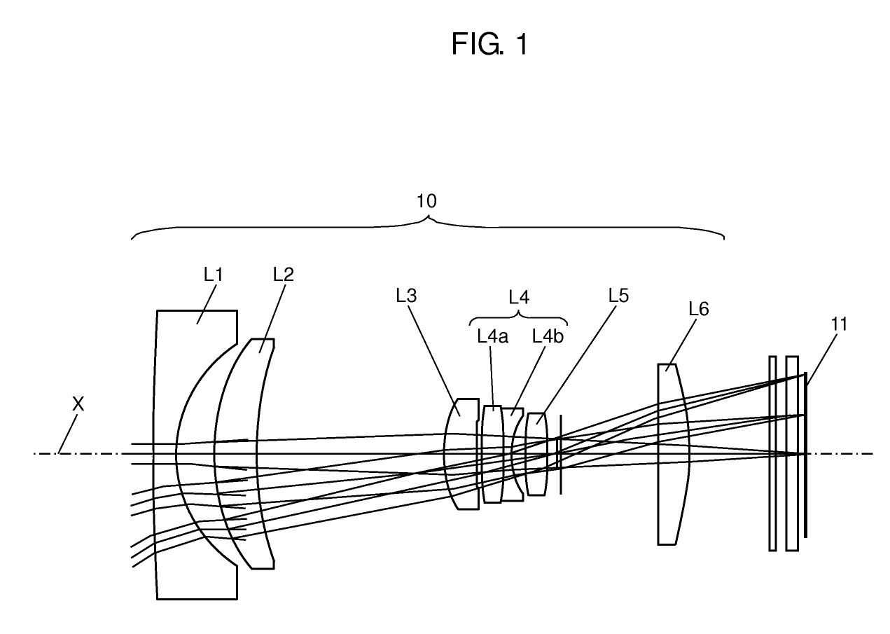

FIG. 1 is a schematic cross-sectional view showing an exemplary optical system used for an imaging device such as a digital camera.

As shown in FIG. 1, optical system 10 is structured by, in order from the subject side, first lens L1, second lens L2, third lens L3, fourth lens L4, fifth lens L5, and sixth lens L6. Further, imaging element 11 is disposed in the optical axis X direction of optical system 10. Fourth lens L4 is a cemented lens structured by two lenses, i.e., fourth lens L4a and fourth lens L4b.

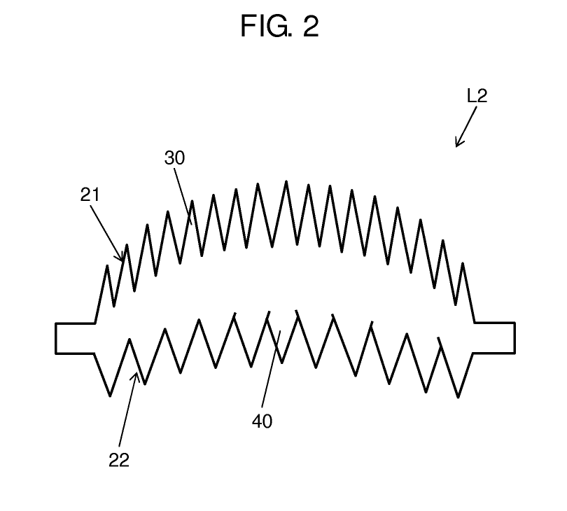

FIG. 2 is a schematic cross-sectional view showing exemplary second lens L2 as an optical member according to one embodiment of the present technique. Note that, in the present embodiment, though the description will be given of the case where second lens L2 has anti-reflective structures, the anti-reflective structures may be formed at other lenses.

As shown in FIG. 2, second lens L2 is a concave meniscus lens whose entrance face 21 is a convex face and whose exit face 22 is a concave face. Second lens L2 is structured by a glass lens. Further, in connection with second lens L2, entrance face 21 being the first face has first microstructure part 30, and exit face 22 being the second face has second microstructure part 40. Herein, each of first microstructure part 30 and second microstructure part 40 is structured by a microstructure part in which a plurality of unit structures such as linear concave or convex parts, conical concave or convex parts, and columnar concave or convex parts are arranged in a pattern with prescribed regularity. Further, the pitch of the unit structures of each of first microstructure part 30 and second microstructure part 40 is equal to or smaller than the wavelength in a range of 400 nm to 750 nm. The microstructure parts form the SWSs. Note that, the unit structures structuring each microstructure part may not have identical dimension, shape and pattern. The unit structures may be formed in a varied manner, in the range where the anti-reflective structure can be formed.

First microstructure part 30 and second microstructure part 40 are each structured by the plurality of unit structures being arranged in a pattern with prescribed regularity. Further, the pitch of the unit structures forming first microstructure part 30 and the pitch of the unit structures of second microstructure part 40 are different from each other. Specifically, the pitch of the unit structures of second microstructure part 40 formed at exit face 22 is greater pitch than the pitch of the unit structures of first microstructure part 30 formed at entrance face 21. Thus, reflection of light having the wavelength being equal to or greater than the pitch of the unit structures can be suppressed. Further, it becomes also possible to reduce an occurrence of unnecessary diffracted light.

Next, a description will be given of the reason why the lens of the present technique can suppress an occurrence of unnecessary diffracted light.

The microstructure part formed on the surface of an optical member such as a lens is a very fine submicron structure. Accordingly, reproduction of the microstructure part during micromachining or molding is extremely difficult. Accordingly, it is desired to further increase the pitch, in order to improve productivity such as micromachining workability or mold reproducibility. On the other hand, a great pitch of the microstructure parts invites an occurrence of unnecessary diffracted light attributed to the micro-asperity structure. Therefore, the pitch must be small enough to avoid an occurrence of unnecessary diffracted light. The pitch with which unnecessary diffracted light attributed to the microstructure parts does not occur can be calculated based on the incident angle of light relative to the lens face and the refractive index of the lens material. However, the pitch conditions differ between the entrance face and the exit face. Therefore, it is preferable to employ the maximum pitch with which diffracted light does not occur for each of the faces of the optical member.

Formula (1) is a conditional expression of a general diffraction. Note that, in Formula (1), A is a pitch of the microstructure parts, θᵢ is the incident angle, θₘ is the diffraction angle, and λ is the wavelength of incident light.

$${n}_{1} sin {θ}_{m} - {n}_{0} sin {θ}_{i} = \frac{m λ}{Λ} \qquad Formula ( 1 )$$

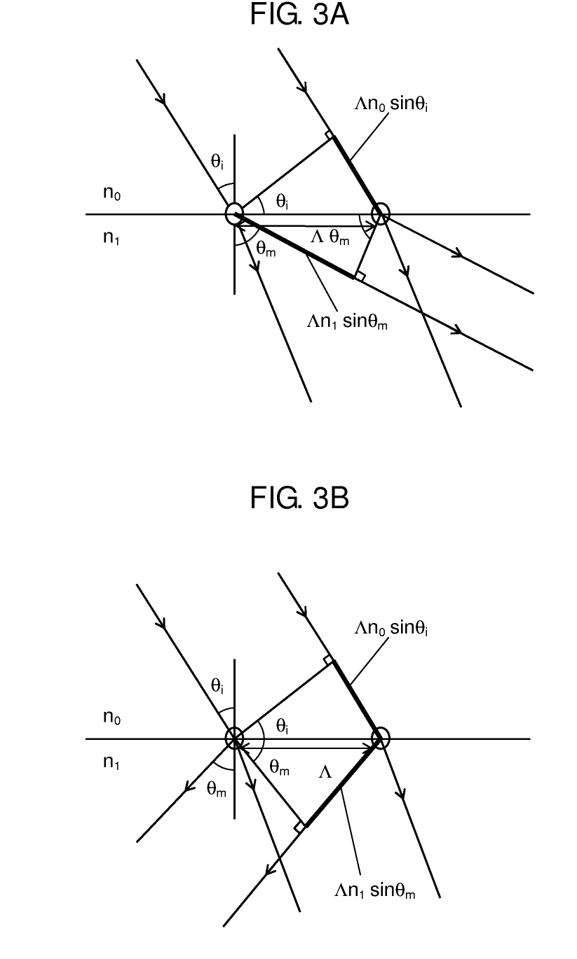

FIGS. 3A and 3B are each an explanatory diagram for describing an occurrence of transmitted diffracted light. FIG. 3A is an explanatory diagram for describing 1st order diffracted light, while FIG. 3B is an explanatory diagram for describing −1st order diffracted light. Note that, though a description will be given of transmitted diffracted light herein, reflected diffracted light can be represented by the similar formula.

Diffracted light occurs when Formula (1) is satisfied. This includes the case where 1st order diffracted light (m=1) occurs as shown in FIG. 3A, and the case where −1st order diffracted light (m=−1) occurs as shown in FIG. 3B.

For each of FIGS. 3A and 3B, the pitch required for the microstructure parts is obtained as follows.

Firstly, in the case of 1st order diffracted light shown in FIG. 3A, substituting m=1 and the maximum value of the diffraction angle θₘ=90° into Formula (1) and expanding Formula (1), the pitch required for the microstructure parts can be represented by Formula (2).

$$Λ < \frac{λ}{{n}_{1} - {n}_{0} sin {θ}_{i}} \qquad Formula ( 2 )$$

Further, similarly in the case of −1st order diffracted light shown in FIG. 3B, substituting m=−1 and the maximum value of diffraction angle θm=−90° into Formula (1) and expanding Formula (1), the pitch required for the microstructure part can be represented by Formula (3).

$$Λ < \frac{λ}{{n}_{1} + {n}_{0} sin {θ}_{i}} \qquad Formula ( 3 )$$

In FIGS. 3A and 3B and Formulas (2) and (3), as to the entrance face of the lens, the refractive index of the air “1” is substituted into n₀ and the refractive index of the glass member structuring the lens is substituted into n₁. As to the exit face of the lens, the refractive index of the glass member structuring the lens is substituted into n₀, and the refractive index of the air “1” is substituted into n₁.

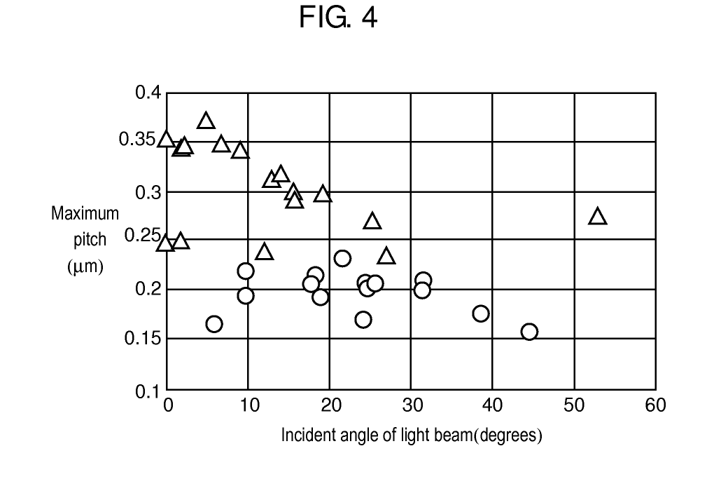

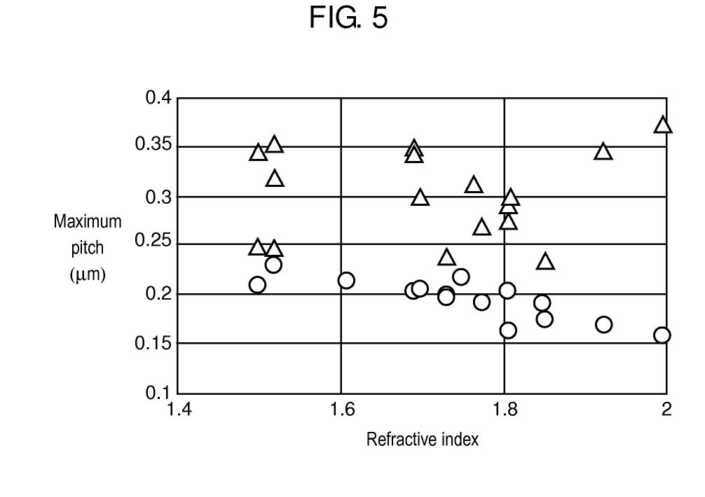

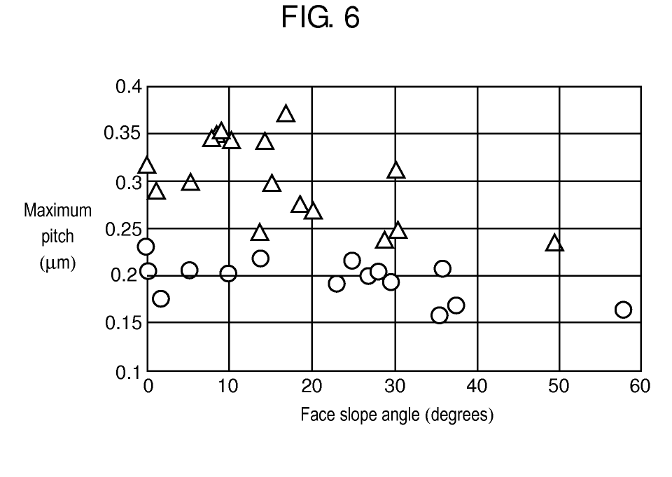

FIGS. 4, 5, and 6 are each a graph showing a result of calculating the maximum pitch with which unnecessary diffracted light does not occur using Formula (3), as to an exemplary case where microstructure parts are formed at lenses each structured as the lens shown in FIG. 1. FIG. 4 is a graph showing the relationship between the incident angle of a light beam and the maximum pitch of the microstructure parts. FIG. 5 is a graph showing the relationship between the refractive index and the maximum pitch of the microstructure parts. FIG. 6 is a graph showing the relationship between the slope of the face and the maximum pitch of the microstructure parts. In FIGS. 4, 5, and 6, “O” represents the entrance face side, while “Δ” represents the exit face side.

As can be seen from FIGS. 4, 5, and 6, an occurrence of unnecessary diffracted light can be suppressed by increase of the pitch at the exit face relative to the pitch at the entrance face.

Next, a description will be given of a lens manufacturing method of the present technique.

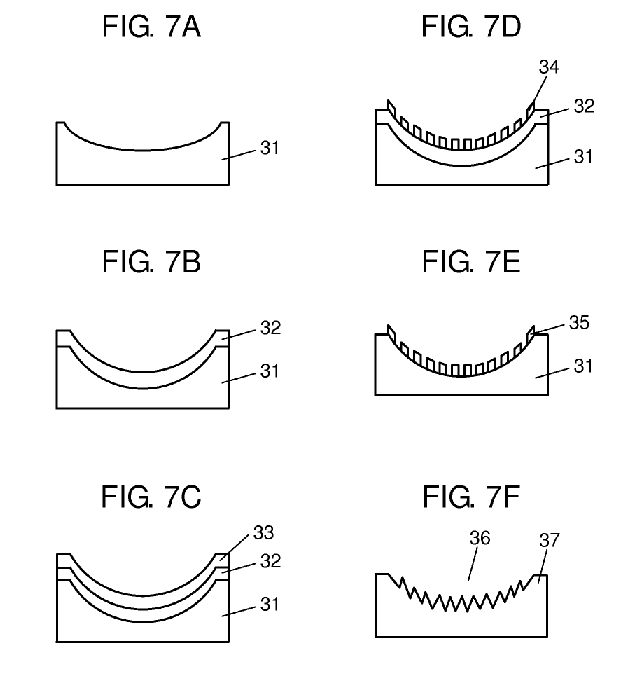

FIGS. 7A to 7F each show a step of fabricating a lens mold for molding the lens shown in FIG. 2, in a lens manufacturing method of the present technique.

Firstly, as shown in FIG. 7A, mold base 31 is prepared. As shown in FIG. 7A, a lens shape is formed on mold base 31 by machine work. Next, as shown in FIG. 7B, metal mask 32 is formed on the surface of mold base 31. It is preferable to form metal mask 32 by sputtering, deposition or the like.

Next, as shown in FIG. 7C, resist mask 33 is formed on metal mask 32. It is preferable to form resist mask 33 by spin coating, spray coating or the like.

Next, as shown in FIG. 7D, resist dot pattern 34 that corresponds to the microstructure part is formed in resist mask 33. It is preferable to form resist dot pattern 34 by electron-beam lithography, interference exposure (hologram exposure) or the like.

Next, as shown in FIG. 7E, resist dot pattern 34 is reproduced in metal mask 32 by dry etching. Thus, metal mask dot pattern 35 is formed. Note that, metal mask dot pattern 35 may be formed by wet etching.

Next, as shown in FIG. 7F, metal mask dot pattern 35 is reproduced in mold base 31 by dry etching. Thus, inverted shape 36 of microstructure part 13 is formed on the surface of mold base 31. With lens mold 37 having inverted shape 36 of microstructure part 13, a lens is fabricated by molding. When the material of the lens is glass, the lens is molded by reheat press molding. When the material of the lens is resin, the lens is molded by injection molding, UV molding or the like.

In the case where electron-beam lithography is used in resist patterning, the pitch in the resist dot pattern can be controlled by adjustment of the setting of the drawing pitch. In the case where interference exposure is used, the pitch in the resist dot pattern can be controlled by adjustment of the interference angle of light. In particular, when the electron-beam lithography is used, the pitch can be finely controlled to achieve a desired pitch by the unit of 1 nm or less.

Note that, though the description of the present preferred embodiment has been made as to the exemplary case where micromachining is performed to the concave-shaped lens mold corresponding to the convex-shaped lens, micromachining of a convex-shaped lens mold corresponding to a concave-shaped lens can be similarly performed.

The present technique provides the advantage of ease in fabricating a lens having an anti-reflective structure. In more detail, as shown in FIG. 2, exit face 22 of the lens is a concave face. In formation of a concave face at a lens, press molding with a lens mold assembly is employed.

Specifically, what are used are an upper mold having an inverted shape of the shape of entrance face 21, i.e., a concave reproducing face, and a lower mold having an inverted shape of exit face 22, i.e., a convex reproducing face. Then, between the upper mold and the lower mold, a glass material made of glass is disposed. By the glass material being pressed against the mold assembly while being heated, the entrance face and the exit face are reproduced on the glass material. Thereafter, the glass material is subjected to the cooling step. The resultant lens is released from the mold assembly by the upper mold and the lower mold being separated. At this time, since the shrinkage ratio of glass is greater than that of the mold assembly, the glass material shrinks greater during the cooling step than the mold assembly does. Since the reproducing face of the upper mold is a concave face, shrinkage of the glass material makes it easier for the glass material to be released from the upper mold. However, since the reproducing face of the lower mold is a convex face, shrinkage of the glass material causes the glass material to strongly attach to the lower mold. Accordingly, it becomes difficult for the glass material to be released from the lower mold. Furthermore, when the microstructure parts are formed on the surfaces of the lens, the surface area of the lens becomes drastically great as compared to the case where no microstructure parts are formed. Accordingly, it becomes difficult for the lens to be released from the mold assembly. As the pitch of the microstructure parts is smaller, the specific surface area becomes greater and releasing from the mold assembly becomes more difficult.

The lens of the present technique is structured such that the pitch of second microstructure part 40 formed on exit face 22 becomes greater than that of first microstructure part 30 formed on entrance face 21. Accordingly, as compared to the case where the microstructure parts are respectively formed at both of the entrance face and the exit face with a similar pitch, the lens can be released from the mold assembly more easily. Thus, an occurrence of cracks in the lens or lacking of the microstructure parts during the release can be suppressed.

Further, since the pitch of the microstructure parts can be increased, molding work also is facilitated. Further, it is preferable that the microstructure parts have a prescribed height irrespective of the pitch of the microstructure parts. Accordingly, it is preferable that the microstructure parts have a similar height irrespective of whether the pitch of the microstructure parts is great or small. Increasing the pitch of the microstructure parts while maintaining the height of the microstructure parts, the aspect ratio of the microstructure parts (the ratio between the height and width of each unit structure of the microstructure parts) becomes smaller. Micromachining such as etching can be performed easier with a smaller aspect ratio than with a higher aspect ratio.

### Example

Next, a description will be given of a specific example.

A lens was molded by reheat press molding, with use of glass as the lens material. Note that, as to the lens shape, concave meniscus lens L2 having a convex R1 surface and a concave R2 surface was molded.

As mold base 31, silicon carbide (SiC) was prepared. A lens shape was formed on mold base 31 by machine work. Tungsten silicide (WSi) was formed by sputtering. Electron-beam resist (positive resist) was applied by spin coating. Thereafter, a dot pattern was drawn by electron beam lithography.

Using the resist dot pattern as a mask, a dot pattern was formed in the W—Si mask by dry etching. Subsequently, a microstructure part was formed on the SiC surface of mold base 31 by dry etching.

On the resultant lens mold provided with the microstructure part by micromachining, a carbon film was formed by sputtering as the releasing process. With use of the mold having undergone the releasing process, a lens was fabricated by reheat press molding with glass.

The pitch in the microstructure part was set to 210 nm for the R1 surface of the lens and to 290 nm for the R2 surface. Then, unnecessary diffracted light was not produced from the molded lens. Furthermore, releasability when the lens was molded was excellent. Even when lenses were successively molded, troubles in releasing the molded products did not occur.

Note that, the material of the mold base 31 is just required to have great strength, and to be capable of easily undergoing micromachining by etching. Exemplary materials include quartz (SiO₂) and silicon carbide (SiC). The material of the metal mask may be Cr, Ta, WSi, Ni, or W. Further, while the description has been exemplarily given of electron-beam lithography as resist patterning, the present technique is not limited thereto. Interference exposure (hologram exposure), or lithography such as x-ray lithography can also be used. Further, nanoimprinting or particle arrangement may be used to form the mask.

Further, in the case where the lens mold is used to form the lens, it is preferable to subject the molding face of the mold to the releasing process before molding is performed. In the case of glass molding, a thin film of carbon, boron nitride, DLC or the like may be formed on the molding face. In the case of resin molding, a fluorine based mold release agent may be applied to the molding face. Such a releasing process can enhance the releasability of the molded product.

As described above, the optical member of the present technique includes: a first face and a second face opposing to each other; a first microstructure part formed at the first face, and including a plurality of unit structures arranged in the first microstructure part; and a second microstructure part formed at the second face, and including a plurality of unit structures arranged in the second microstructure part. The pitch of the unit structures forming the first microstructure part and the pitch of the unit structures forming the second microstructure part are different from each other. Thus, reflection of light having a wavelength being equal to or greater than the pitch of the unit structures can be suppressed. Further, an occurrence of unnecessary diffracted light can be suppressed. Furthermore, an advantage of ease of fabricating an optical member having an anti-reflective structure can be achieved.

In the foregoing, the preferred embodiment has been shown by the detailed description and accompanying drawings. The preferred embodiment has been set forth for illustrating the subject matter defined by the claims to a person skilled in the art with reference to the specific preferred embodiment. Accordingly, the constituents shown in the detailed description and accompanying drawings may include not only the constituents essential for solving the problems, but also other constituents. Accordingly, such non-essential constituents are not to be immediately construed to be essential based on the fact that the non-essential constituents are shown in the detailed description and accompanying drawings. Further, various changes, replacement, addition, elimination can be made to the preferred embodiment in the scope of claims and equivalents thereof.

The optical member of the present technique exhibits an anti-reflection effect and has high environmental resistance, and hence is useful as a lens barrel, and an optical element represented by a lens. Use of the optical member of the present technique can implement various types of high-quality optical systems, such as an imaging optical system, an objective optical system, a scanning optical system, and a pickup optical system, various types of optical units such as a lens barrel unit, an optical pickup unit, and an imaging unit, and an imaging device, an optical pickup device, an optical scanning device and the like.

What is claimed is:

1. An optical member comprising:
a first face and a second face opposing to each other;
a first microstructure part formed at the first face, and including a plurality of unit structures arranged in the first microstructure part; and
a second microstructure part formed at the second face, and including a plurality of unit structures arranged in the second microstructure part, wherein
a pitch of the unit structures forming the first microstructure part and a pitch of the unit structures forming the second microstructure part are different from each other.

2. The optical member according to claim 1, wherein
the first face is an entrance face for light,
the second face is an exit face for light, and
the pitch of the unit structures forming the second microstructure part is greater than the pitch of the unit structures forming the first microstructure part.

3. The optical member according to claim 1, wherein
the pitch of the unit structures of each of the first microstructure part and the second microstructure part is equal to or smaller than a wavelength in a range from 400 nm to 750 nm.
